(19) United States
(12) Patent Application Publication
(10) Pub. No.: US 2023/0235487 A1
(43) Pub. Date: Jul. 27, 2023

(54) BICOMPONENT FIBERS INCLUDING AN ETHYLENE/ALPHA-OLEFIN INTERPOLYMER AND POLYESTER

(71) Applicant: Dow Global Technologies LLC, Midland, MI (US)

(72) Inventors: Akanksha Garg, Pearland, TX (US); Yijian Lin, Pearland, TX (US); Aleksandar Stoiljkovic, Waedenswil (CH); John P. O'Brien, Manvel, TX (US); Jozef J. I. Van Dun, Antwerp (BE); Fabricio Arteaga Larios, Sugar Land, TX (US)

(21) Appl. No.: 17/996,757

(22) PCT Filed: May 5, 2021
(86) PCT No.: PCT/US2021/030894

§ 371 Date: Oct. 20, 2022

Related U.S. Application Data
(60) Provisional application No. 63/021,780, filed on May 8, 2020.

(51) Int. Cl. D01F 8/06; D01F 8/14; D04H 3/007; D04H 3/011; D01D 5/32; D01D 5/34; D04H 3/147

(52) U.S. Cl. CPC D01F 8/06; D01D 5/32; D01D 5/34; D01F 8/14; D04H 3/007; D04H 3/011; D04H 3/147; D10B 2321/021; D10B 2331/04

(57) ABSTRACT

Provided are bicomponent fibers with improved curvature. The bicomponent fibers comprise a first polymer region or first region and a second polymer region or second region. The first region according to embodiments of the present disclosure comprises an ethylene/alpha-olefin interpolymer and has a light scattering cumulative detector fraction (CDF_{LS}) of greater than 0.1200, wherein the CDF_{LS} is computed by measuring the area fraction of a low angle laser light scattering (LALLS) detector chromatogram greater than, or equal to, 1,000,000 g/mol molecular weight using Gel Permeation Chromatography (GPC). The second region comprises a polyester. The bicomponent fibers can be used for forming nonwovens.

### TECHNICAL FIELD

Embodiments of the present disclosure generally relate to bicomponent fibers with curvature that comprise an ethylene/alpha-olefin interpolymer and polyester, and nonwovens comprising the fibers.

### INTRODUCTION

Bicomponent fibers are fibers made of two different polymer compositions that are extruded from the same spinneret with both compositions contained within the same filament or fiber. When the fiber leaves the spinneret, it consists of non-mixed components that are fused at the interface. The two polymer compositions can differ in their chemical and/or physical properties. Bicomponent fibers can be formed by conventional spinning techniques known in the art and can be used for forming a nonwoven. Nonwoven fabrics have numerous applications, such as filters, disposable materials in medical applications, and diaperstock. To assist in reducing nonwoven weight or obtaining other nonwoven advantageous properties, such as loft, bicomponent fibers having curvature can be used. However, problems exist with obtaining bicomponent fibers with increased curvature and with maintaining or improving other advantageous properties, such as spinnability, stiffness, and tensile strength, while improving curvature.

### SUMMARY

Embodiment of the present disclosure provide bicomponent fibers that can be used to form nonwovens and that provide in aspects unique and surprisingly high curvature, while also maintaining or improving other properties such as spinnability, stiffness, and tensile strength. Bicomponent fibers according to embodiments of the present disclosure each include a first polymer region and a second polymer region comprising a first polymer and a second polymer, respectively, that contribute to a fiber with improved curvature. Specifically, bicomponent fibers according to embodiments of the present disclosure comprise a first polymer region or first region comprising an ethylene/alpha-olefin interpolymer that can provide softness and a second polymer region or second region comprising a polyester that can provide high tensile strength, stiffness, and spinnability. The improved curvature of the fibers disclosed herein is not the result of mechanical crimping or a post-extrusion process, such as attenuation with heated air or application of tension.

Disclosed herein is a bicomponent fiber. In embodiments, the bicomponent fiber comprises a fiber centroid; a first region having a first centroid and a second region having a second centroid; the first region comprising an ethylene/alpha-olefin interpolymer in an amount of at least 50 weight percent based on total weight of the first region and from 0 to 40 weight percent of a low density polyethylene based on total weight of the first region; the first region having a light scattering cumulative detector fraction (CDF_{LS}) of greater than 0.1200, wherein the CDF_{LS} is computed by measuring the area fraction of a low angle laser light scattering (LALLS) detector chromatogram greater than, or equal to, 1,000,000 g/mol molecular weight using Gel Permeation Chromatography (GPC); the second region comprising a polyester; and wherein at least one of the first centroid and the second centroid is not the same as the fiber centroid.

In further embodiments, a bicomponent fiber is disclosed, wherein the fiber has a light scattering cumulative detector fraction (CDF_{LS}) of greater than 0.1600, wherein the CDF_{LS} is computed by measuring the area fraction of a low angle laser light scattering (LALLS) detector chromatogram greater than, or equal to, 1,000,000 g/mol molecular weight using Gel Permeation Chromatography (GPC). In such embodiments, the bicomponent fiber comprises a fiber centroid; a first region having a first centroid and a second region having a second centroid; the first region comprising an ethylene/alpha-olefin interpolymer in an amount of at least 50 weight percent based on total weight of the first region and from 0 to 40 weight percent of a low density polyethylene based on total weight of the first region; the second region comprising a polyester; wherein at least one of the first centroid and the second centroid is not the same as the fiber centroid; and wherein the fiber has a light scattering cumulative detector fraction (CDF_{LS}) of greater than 0.1600, wherein the CDF_{LS} is computed by measuring the area fraction of a low angle laser light scattering (LALLS) detector chromatogram greater than, or equal to, 1,000,000 g/mol molecular weight using Gel Permeation Chromatography (GPC).

Also disclosed herein are nonwovens comprising bicomponent fibers. In embodiments, the nonwoven comprises a bicomponent fiber, wherein the bicomponent fiber comprises a fiber centroid; a first region having a first centroid and a second region having a second centroid; the first region comprising an ethylene/alpha-olefin interpolymer in an amount of at least 50 weight percent based on total weight of the first region and from 0 to 40 weight percent of a low density polyethylene based on total weight of the first region; the first region having a light scattering cumulative detector fraction (CDF_{LS}) of greater than 0.1200, wherein the CDF_{LS} is computed by measuring the area fraction of a low angle laser light scattering (LALLS) detector chromatogram greater than, or equal to, 1,000,000 g/mol molecular weight using Gel Permeation Chromatography (GPC); the second region comprising a polyester; and wherein at least one of the first centroid and the second centroid is not the same as the fiber centroid.

Additional features and advantages of the embodiments will be set forth in the detailed description which follows, and in part will be readily apparent to those skilled in the art from that description or recognized by practicing the embodiments described herein, including the detailed description which follows, the claims, as well as the appended drawing.

It is to be understood that both the foregoing and the following description describe various embodiments and are intended to provide an overview or framework for understanding the nature and character of the claimed subject matter. The accompanying figure is included to provide a further understanding of the various embodiments, and is incorporated into and constitute a part of this specification.

### BRIEF DESCRIPTION OF THE DRAWINGS

FIG. 1 is a scanning electron micrograph (SEM) cross-section image of an eccentric core sheath bicomponent fiber.

FIG. 2 is a schematic of the reactor stream feed data flows that correspond to a developmental resin used in the examples.

### DETAILED DESCRIPTION

Aspects of the disclosed bicomponent fibers are described in more detail below. The bicomponent fibers having increased curvature can be used to form nonwovens, and such nonwovens can have a wide variety of applications. It is noted however, that this is merely an illustrative implementation of the embodiments disclosed herein. The embodiments are applicable to other technologies that are susceptible to similar problems as those discussed above.

As used herein, the terms “comprising,” “including,” “having,” and their derivatives, are not intended to exclude the presence of any additional component, step or procedure, whether or not the same is specifically disclosed. In order to avoid any doubt, all compositions claimed through use of the term “comprising” may include any additional additive, adjuvant, or compound, whether polymeric or otherwise, unless stated to the contrary. In contrast, the term, “consisting essentially of” excludes from the scope of any succeeding recitation any other component, step or procedure, excepting those that are not essential to operability. The term “consisting of” excludes any component, step or procedure not specifically delineated or listed.

As used herein, the term “interpolymer” refers to polymers prepared by the polymerization of at least two different types of monomers. The term interpolymer thus includes copolymers (employed to refer to polymers prepared from two different types of monomers), and polymers prepared from more than two different types of monomers.

As used herein, the term “polymer” means a polymeric compound prepared by polymerizing monomers, whether of the same or a different type. The term polymer thus embraces the term homopolymer (employed to refer to polymers prepared from only one type of monomer, with the understanding that trace amounts of impurities can be incorporated into the polymer structure), and the term interpolymer as defined above. Trace amounts of impurities (for example, catalyst residues) may be incorporated into and/or within the polymer. A polymer may be a single polymer or a polymer blend.

As used herein, the term “polyolefin” refers to a polymer that comprises, in polymerized form, a majority amount of olefin monomer, for example ethylene or propylene (based on the weight of the polymer), and optionally may comprise one or more comonomers

As used herein, the term “polyester” refers to a polymer produced from the reaction of a hydroxyl (—OH) containing material with a polycarboxylic acid or an anhydride thereof or of at least one carboxylic acid and at least one polyfunctional alcohol, for instance, a diol, triol or other polyol which reaction product thus has more than one ester group and itself has an average of more than one hydroxyl group.

As used herein, the terms “nonwoven,” “nonwoven web,” and “nonwoven fabric” are used herein interchangeably. “Nonwoven” refers to a web or fabric having a structure of individual fibers or threads which are randomly interlaid, but not in an identifiable manner as is the case for a knitted fabric.

As used herein, the term “curvature” refers to the curve or crimp of an individual fiber that is result of its composition and not the result of any post-extrusion process that can impact the curve or crimp of the fiber (e.g., mechanical crimping or attenuation by heat). The amount of curvature of the bicomponent fibers disclosed herein can be measured in accordance with the test method described below.

As used herein, the term “spunbond” refers to the fabrication of nonwoven fabric including the following steps: (a) extruding molten thermoplastic strands from a plurality of fine capillaries called a spinneret; (b) quenching the strands with a flow of air which is generally cooled in order to hasten the solidification of the molten strands; (c) attenuating the stands by advancing them through the quench zone with a draw tension that can be applied by either pneumatically entraining the stands in an air stream or by winding them around mechanical draw rolls of the type commonly used in the textile fibers industry; (d) collecting the drawn strands into a web on a foraminous surface, e.g., moving screen or porous belt; and (e) bonding the web of loose strands into a nonwoven fabric. Bonding can be achieved by a variety of means including, but not limited to, thermo-calendaring process, adhesive bonding process, hot air bonding process, needle punch process, hydroentangling process, and combinations thereof.

As used herein, the term “meltblown” refers to the fabrication of nonwoven fabrics via a process which generally includes the following steps: (a) extruding molten thermoplastic strands from a spinneret; (b) simultaneously quenching and attenuating the polymer stream immediately below the spinneret using streams of high velocity heated air; (c) collecting the drawn strands into a web on a collecting surface. Meltblown webs can be bonded by a variety of means including, but not limited to, autogeneous bonding, i.e., self bonding without further treatment, thermo-calendaring process, adhesive bonding process, hot air bonding process, needle punch process, hydroentangling process, and combinations thereof.

### Fibers

The bicomponent fiber according to embodiments of the present disclosure can be formed into a fiber via different techniques, for example, via melt spinning. In melt spinning, the first region and second region can be melted, coextruded and forced through fine orifices in a metallic plate, spinneret, into air or other gas, where the coextruded regions are cooled and solidified for forming bicomponent fibers. The solidified filaments can be drawn off via air jets, rotating rolls, or godets, and can be laid on a conveyer belt as a web for forming a nonwoven. A nonwoven comprising the bicomponent fibers disclosed here can be formed via different techniques. For example, in one embodiment, a spunbond nonwoven comprising the bicomponent fibers disclosed herein can be formed. In other embodiments, a meltblown nonwoven comprising the bicomponent fibers disclosed herein can be formed.

The bicomponent fiber disclosed herein has improved curvature. In embodiments described herein, the bicomponent fiber has a curvature of at least 1.10 mm⁻¹. The curvature of the bicomponent fiber can be measured in accordance with the test method described below. All individual values and subranges of at least 1.10 mm⁻¹ are disclosed and included herein. For example, in some embodiments, the bicomponent fiber can have a curvature of at least 1.20, 1.30, 1.40, or 1.50 mm⁻¹, when measured according to the test method described below. In other embodiments, the bicomponent fiber can have a curvature in the range of from 1.10 to 6.00, from 1.10 to 5.00, from 1.10 to 4.00, from 1.10 to 3.00, from 1.10 to 2.00, from 1.10 to 1.90, from 1.20 to 6.00, from 1.20 to 5.00, from 1.20 to 4.00, from 1.20 to 3.00, from 1.20 to 2.00, from 1.30 to 6.00, from 1.30 to 5.00, from 1.30 to 4.00, from 1.30 to 3.00, from 1.30 to 2.00, 1.40 to 6.00, 1.40 to 5.00, 1.40 to 4.00, 1.40 to 3.00, 1.40 to 2.00, 1.50 to 6.00, 1.50 to 5.00, 1.50 to 4.00, 1.50 to 3.00, or 1.50 to 2.00 mm⁻¹, when measured according to the test method described below.

In embodiments, the bicomponent fiber comprises a first region and a second region, wherein the weight ratio of the first region to the second region is 90:10 to 10:90. All individual values and subranges of a ratio of from 90:10 to 10:90 are disclosed and included herein. For example, in embodiments, the weight ratio of the first region to the second region is from 90:10 to 10:90, from 80:20 to 20:80, from 70:30 to 30:70, from 60:40 to 40:60, or from 55:45 to 45:55.

In embodiments, the bicomponent fiber has a light scattering cumulative detector fraction (CDF_{LS}) of greater than 0.1500, wherein the CDF_{LS} is computed by measuring the area fraction of a low angle laser light scattering (LALLS) detector chromatogram greater than, or equal to, 1,000,000 g/mol molecular weight using Gel Permeation Chromatography (GPC). All individual values and subranges of a CDF_{LS} of greater than 0.1600 are disclosed and included herein. For example, in some embodiments, the bicomponent fiber can have a CDF_{LS} greater than 0.1600, greater than 0.2000, greater than 0.2200, greater than 0.2400, or greater than 0.2600, where the CDF_{LS} is computed by measuring the area fraction of a low angle laser light scattering (LALLS) detector chromatogram greater than, or equal to, 1,000,000 g/mol molecular weight using Gel Permeation Chromatography (GPC). In other embodiments, the bicomponent fiber can have a CDF_{LS} in the range of from 0.1500 to 0.5000, from 0.1600 to 0.5000, from 0.2000 to 0.5000, from 0.2500 to 0.5000, from 0.3000 to 0.5000, from 0.1600 to 0.4500, 0.2000 to 0.4500, 0.2500 to 0.4500, 0.3000 to 0.4500, from 0.2000 to 0.4000, from 0.2500 to 0.4000, from 0.2000 to 0.3500, or from 0.2500 to 0.3500, where the CDF_{LS} is computed by measuring the area fraction of a low angle laser light scattering (LALLS) detector chromatogram greater than, or equal to, 1,000,000 g/mol molecular weight using Gel Permeation Chromatography (GPC).

In embodiments, the bicomponent fiber has an infrared cumulative detector fraction (CDF_{IR}) of greater than 0.0100 wherein the CDF_{IR} is computed by measuring the area fraction of an IR5 measurement channel (IR) detector chromatogram greater than, or equal to, 350,000 g/mol molecular weight using Gel Permeation Chromatography (GPC). All individual values and subranges of a CDF_{IR} of greater than 0.0100 are disclosed and included herein. For example, in some embodiments, the bicomponent fiber can have a CDF_{IR} greater than 0.0150, greater than 0.0200, or greater than 0.0225, where the CDF_{IR} is computed by measuring the area fraction of an IR5 measurement channel (IR) detector chromatogram greater than, or equal to, 350,000 g/mol molecular weight using Gel Permeation Chromatography (GPC). In other embodiments, the bicomponent fiber can have a CDF_{IR} in the range of from 0.0100 to 0.1500, from 0.0100 to 0.1300, from 0.0100 to 0.1100, from 0.0100 to 0.0900, from 0.0100 to 0.0700, from 0.0100 to 0.0500, from 0.0100 to 0.0400, from 0.0200 to 0.1500, from 0.0200 to 0.1300, from 0.0200 to 0.1100, from 0.0200 to 0.0900, from 0.0200 to 0.0700, from 0.0200 to 0.0500, from 0.0200 to 0.0300, from 0.0300 to 0.1500, from 0.0300 to 0.1300, from 0.0300 to 0.1100, from 0.0300 to 0.0900, from 0.0300 to 0.0700, from 0.0300 to 0.0500, or from 0.0300 to 0.0400, where the CDF_{IR} is computed by measuring the area fraction of an IR5 measurement channel (IR) detector chromatogram greater than, or equal to, 350,000 g/mol molecular weight using Gel Permeation Chromatography (GPC).

### Centroids

In embodiments, the bicomponent fiber comprises a fiber centroid and a first region having a first centroid and a second region having a second centroid, wherein at least one of the first centroid and the second centroid is not the same as the fiber centroid.

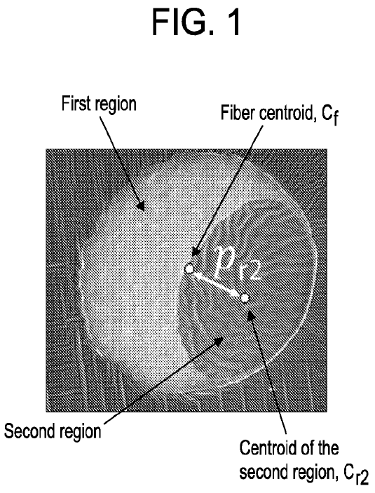

As used herein, the term “centroid” refers to the arithmetic mean of all the points of a region of a cross-section of a bicomponent fiber. For example, the bicomponent fiber according to embodiments of the present disclosure has a fiber centroid, which can be designated as C_{f}, and a region of the bicomponent fiber (e.g., the first or second region) has an independent centroid, which can be designated as Cᵣₓ, where x is a designation of the region (e.g., the first region can be designated as Cᵣ₁ and the second region can be designates as Cᵣ₂), and where “r” is the average distance from C_{f} to the outer surface of the bicomponent fiber and is calculated as

$$\sqrt{A / π} ,$$

where A is the area of the bicomponent fiber cross-section. FIG. 1 illustrates a bicomponent fiber and its centroid as well as the centroid of the second region of the bicomponent fiber. The distance from a region centroid to the fiber centroid can be defined as “Pᵣₓ”, and the centroid offset of the first centroid or second centroid to the fiber centroid can be defined as “Pᵣₓ/r.”

In embodiments, at least one of the first centroid and the second centroid is not the same as the fiber centroid. Where the first centroid or the second centroid are different than the fiber centroid, the bicomponent fiber can have different configurations, such as eccentric core-sheath or side-by-side, but cannot have a concentric configuration (e.g., a core-sheath concentric configuration) where the fiber centroid, first centroid, and the second centroid are the same. In embodiments, the first centroid of the first region and the second centroid of the second region are arranged such that the first region and the second region are in a side-by-side configuration. In other embodiments, the first centroid of the first region and the second centroid of the second region are arranged such that the first region and the second region are in a segmented pie configuration. In further embodiments, the first centroid of the first region and the second centroid of the second region are arranged such that the first region and the second region are in an eccentric core-sheath configuration, where the first region is the sheath of the bicomponent fiber and the second region is the core region of the bicomponent fiber and the sheath region surrounds the core region.

In embodiments, the first centroid or the second centroid is off-set from the fiber centroid by at least 0.1, or at least 0.2, or at least 0.4, and is less than 1 or less than 0.9, where off-set is measured in accordance with the test method described below.

### First Region and Ethylene/alpha-olefin Interpolymer

In embodiments, the first region of the bicomponent fiber comprises an ethylene/alpha-olefin interpolymer in an amount of at least 50 weight percent (wt.%) based on total weight of the first region.

The term “ethylene/alpha-olefin interpolymer” generally refers to polymers comprising ethylene and an alpha-olefin having 3 or more carbon atoms. The ethylene/alpha-olefin interpolymer of the first region comprises greater than 70 wt.% of the units derived from ethylene and less than 30 wt.% of the units derived from one or more alpha-olefin comonomers (based on the total amount of polymerizable monomers). All individual values and subranges of greater than 70 wt.% of the units derived from ethylene and less than 30 wt.% of the units derived from one or more alpha-olefin comonomers are included and disclosed herein. For example, in one or more embodiments, either or both of the ethylene/alpha-olefin interpolymers may comprise (a) greater than or equal to 75%, greater than or equal to 80%, greater than or equal to 85%, greater than or equal to 90%, greater than or equal to 92%, greater than or equal to 95%, greater than or equal to 97%, greater than or equal to 98%, greater than or equal to 99%, greater than or equal to 99.5%, from greater than 70% to 99%, from greater than 70% to 97%, from greater than 70% to 94%, from greater than 70% to 90%, from 70% to 99.5%, from 70% to 99%, from 70% to 97% from 70% to 94%, from 80% to 99.5%, from 80% to 99%, from 80% to 97%, from 80% to 94%, from 80% to 90%, from 85% to 99.5%, from 85% to 99%, from 85% to 97%, from 88% to 99.9%, 88% to 99.7%, from 88% to 99.5%, from 88% to 99%, from 88% to 98%, from 88% to 97%, from 88% to 95%, from 88% to 94%, from 90% to 99.9%, from 90% to 99.5% from 90% to 99%, from 90% to 97%, from 90% to 95%, from 93% to 99.9%, from 93% to 99.5% from 93% to 99%, or from 93% to 97%, by weight, of the units derived from ethylene; and (b) less than 30 percent, for example, less than 25 percent, or less than 20 percent, less than 18%, less than 15%, less than 12%, less than 10%, less than 8%, less than 5%, less than 4%, less than 3%, less than 2%, less than 1%, from 0.1 to 20 %, from 0.1 to 15 %, 0.1 to 12%, 0.1 to 10%, 0.1 to 8%, 0.1 to 5%, 0.1 to 3%, 0.1 to 2%, 0.5 to 12%, 0.5 to 10%, 0.5 to 8%, 0.5 to 5%, 0.5 to 3%, 0.5 to 2.5%, 1 to 10%, 1 to 8%, 1 to 5%, 1 to 3%, 2 to 10%, 2 to 8%, 2 to 5%, 3.5 to 12%, 3.5 to 10%, 3.5 to 8%, 3.5% to 7%, or 4 to 12%, 4 to 10%, 4 to 8%, or 4 to 7%, by weight, of units derived from one or more α-olefin comonomers. The comonomer content may be measured using any suitable technique, such as techniques based on nuclear magnetic resonance (“NMR”) spectroscopy, and, for example, by ¹³C NMR analysis as described in U.S. Pat. 7,498,282, which is incorporated herein by reference.

Suitable alpha-olefin comonomers typically have no more than 20 carbon atoms. The one or more alpha-olefins may be selected from the group consisting of C3-C20 acetylenically unsaturated monomers and C4-C18 diolefins. For example, the alpha-olefin comonomers may have 3 to 10 carbon atoms, or 3 to 8 carbon atoms. Exemplary alpha-olefin comonomers include, but are not limited to, propylene, 1-butene, 1-pentene, 1-hexene, 1-heptene, 1-octene, 1-nonene, 1-decene, and 4-methyl-1-pentene. The one or more alpha-olefin comonomers may, for example, be selected from the group consisting of propylene, 1-butene, 1-hexene, and 1-octene; or in the alternative, from the group consisting of 1-butene, 1-hexene and 1-octene, or in the alternative, from the group consisting of 1-hexene and 1-octene. In one or more embodiments, each of the ethylene/alpha-olefin interpolymers may comprise greater than 0 wt. % and less than 30 wt. % of units derived from one or more of 1-octene, 1-hexene, or 1-butene comonomers.

As noted above, the first region comprises an ethylene/alpha-olefin interpolymer in an amount of at least 50 weight percent based on total weight of the first region. All individual values and subranges of at least 50 weight percent (wt.%) based on total weight of the first region are included and disclosed herein. For example, in one or more embodiments, the first region comprises an ethylene/alpha-olefin interpolymer in an amount of at least 50 wt.%, at least 60 wt.%, at least 70 wt.%, at least 75 wt.%, at least 80 wt.%, at least 90 wt.%, at least 95 wt.%, at least 99 wt.%, at least 99.5 wt.%, or at least 99.9 wt.%, based on total weight of the first region. In other embodiments, the first region comprises an ethylene/alpha-olefin interpolymer in an amount of from 50 to 60 wt.%, from 50 to 70 wt.%, from 50 to 80 wt.%, from 50 to 90 wt.%, from 50 to 99 wt.%, from 50 to 100 wt.%, from 60 to 70 wt.%, from 60 to 80 wt.%, from 60 to 90 wt.%, from 60 to 99 wt.%, from 60 to 100 wt.%, from 70 to 80 wt.%, from 70 to 90 wt.%, from 70 to 99 wt.%, from 70 to 100 wt.%, from 80 to 90 wt.%, from 80 to 99 wt.%, from 90 to 99 wt.%, and from 90 to 100 wt.%, based on total weight of the first region of the bicomponent fiber.

In embodiments, the ethylene/alpha-olefin interpolymer has a density in the range of from 0.910 to 0.964 g/cm³. All individual values and subranges of a density in the range of from 0.910 to 0.964 g/cm³ are disclosed and included herein. For example, in some embodiments, the ethylene/alpha-olefin interpolymer can have a density in the range of from 0.910 to 0.964, from 0.910 to 0.960, from 0.920 to 0.960, from 0.930 to 0.960, from 0.940 to 0.960, from 0.950 to 0.960, from 0.910 to 0.950, from 0.920 to 0.950, from 0.930 to 0.950, from 0.940 to 0.950, from 0.910 to 0.940, from 0.920 to 0.940, from 0.930 to 0.940, from 0.910 to 0.930, from 0.920 to 0.930, or from 0.910 to 0.920 g/cm³, where density can be measured according to ASTM D792.

In embodiments, the ethylene/alpha-olefin interpolymer has a melt index (I2), measured according to ASTM D1238, 190° C., 2.16 kg, in the range of from 10 to 60 g/10 minutes. All individual values and subranges of from 10 to 60 g/10 minutes are included and disclosed herein. For example, in some embodiments, the ethylene/alpha-olefin interpolymer can have a melt index (I2) in the range of from 10 to 60 g/10 minutes, from 10 to 50 g/10 minutes, from 10 to 40 g/10 minutes, from 10 to 30 g/10 minutes, from 10 to 20 g/10 minutes, from 20 to 60 g/10 minutes, from 20 to 50 g/10 minutes, from 20 to 40 g/10 minutes, from 20 to 30 g/10 minutes, from 15 to 60 g/10 minutes, from 15 to 50 g/10 minutes, from 15 to 40 g/10 minutes, from 15 to 30 g/10 minutes, or from 15 to 20 g/10 minutes, where melt index (I2) can be measured according to ASTM D1238, 190° C., 2.16 kg.

In embodiments, the ethylene/alpha-olefin interpolymer has a molecular weight distribution, expressed as the ratio of the weight average molecular weight to number average molecular weight (M_{w(GPC)}/M_{n(GPC)}), of greater than 3.0. All individual values and subranges of a molecular weight distribution (M_{w(GPC)}/M_{n(GPC)}) of greater than 3.0 are disclosed and included herein; for example, in embodiments, the ethylene/alpha-olefin interpolymer has a molecular weight distribution (M_{w(GPC)}/M_{n(GPC)}) of greater than 3.0, greater than 3.02, greater than 3.04, greater than 3.06, greater than 3.08, greater than 3.10, greater than 3.12, or greater than 3.14, or from a range of from 3.0 to 5.0, 3.0 to 4.5, 3.0 to 4.0, 3.0 to 3.5, 3.0 to 3.2, 3.1 to 5.0, 3.1 to 4.5, 3.1 to 4.0, 3.1 to 3.5, or 3.1 to 3.2, where molecular weight distribution can be expressed as the ratio of the weight average molecular weight to number average molecular weight (M_{w(GPC)}/M_{n(GPC)}).

In embodiments, the first region has a molecular weight distribution, expressed as the ratio of the weight average molecular weight to number average molecular weight (M_{w(GPC)}/M_{n(GPC)}), of greater than 3.35. All individual values and subranges of a molecular weight distribution (M_{w(GPC)}/M_{n(GPC)}) of greater than 3.35 are disclosed and included herein; for example, in embodiments, the first region has a molecular weight distribution (M_{w(GPC)}/M_{n(GPC)}) of greater than 3.35, or greater than 3.50, greater than 3.75, greater than 4.00, greater than 4.25, greater than 4.50, greater than 4.75, or greater than 4.90, or from a range of from 3.35 to 6.00, 3.35 to 5.50, or 3.35 to 5.00, where molecular weight distribution can be expressed as the ratio of the weight average molecular weight to number average molecular weight (M_{w(GPC)}/M_{n(GPC)}).

In embodiments, the first region of the bicomponent fiber further comprises from 0 to 40 weight percent of a low density polyethylene based on total weight of the first region. All individual values and subranges of from 0 to 40 weight percent (wt.%) are disclosed and included herein; for example, in embodiments, the first region comprises from 0 to 40 wt.%, from 0 to 30 wt.%, from 0 to 20 wt.%, from 0 to 10 wt.%, from 10 to 40 wt.%, from 10 to 30 wt.%, from 10 to 20 wt.%, from 15 to 40 wt.%, from 15 to 30 wt.%, from 15 to 25 wt.%, from 20 to 40 wt.%, from 20 to 30 wt.%, or from 30 to 40 wt.%, of a low density polyethylene based on the total weight of the first region.

In embodiments, the first region can comprise further components, such as, one or more other polymers, polymer blends, and/or one or more additives. Other polymers or polymer blends can include another polyethylene (e.g. polyethylene homopolymer or ethylene/alpha-olefin interpolymer), polyester, propylene-based polymer (e.g. polypropylene homopolymer, propylene-ethylene copolymer, or propylene/alpha-olefin interpolymer), or propylene-based plastomers or elastomers. The amount of the other polymer or other polymer blends may be up to 50 wt. % based on the total weight of the first region. For example, in embodiments, the first region can comprise up to 50 wt. % of propylene-based plastomers or propylene-based elastomers (such as VERSIFY® polymers available from The Dow Chemical Company and VISTAMAXX® polymers available from ExxonMobil Chemical Co.), low modulus or/and low molecular weight polypropylene (such as L-MODU® polymer from Idemitsu), random copolypropylene, or propylene-based olefin block copolymers (such as Intune). Potential additives include, but are not limited to, antistatic agents, color enhancers, dyes, lubricants, fillers, pigments, primary antioxidants, secondary antioxidants, processing aids, UV stabilizers, anti-blocks, slip agents, tackifiers, fire retardants, anti-microbial agents, odor reducer agents, anti-fungal agents, and combinations thereof. The first region can contain from about 0.01 or 0.1 or 1 to about 25 or about 20 or about 15 or about 10 weight percent by the combined weight of such additives, based on the weight of the first region including such additives.

In embodiments, the first region can further comprise a polyolefin elastomer. For example, polyolefin elastomer can be provided to increase the extensibility of a nonwoven formed from bicomponent fibers described herein. In some embodiments, the polyolefin elastomer can be a block copolymer. In some embodiments where polyolefin elastomer is used in the first region, the first region can comprise 50 weight percent (wt.%) or less of the polyolefin elastomer based on the total weight of the first region. Examples of commercially available polyolefin elastomers that can be used in some embodiments of the present invention include, polyolefin elastomers available from The Dow Chemical Company under the names VERSIFY® ENGAGE®, AFFINITY®, and INFUSE®, polyolefin elastomers available from ExxonMobil Chemical Co. under the name VISTAMAXX®, and polyolefin elastomers available from Idemitsu under the name L-MODU®.

In embodiments, the first region has a light scattering cumulative detector fraction (CDF_{LS}) of greater than 0.1200, wherein the CDF_{LS} is computed by measuring the area fraction of a low angle laser light scattering (LALLS) detector chromatogram greater than, or equal to, 1,000,000 g/mol molecular weight using Gel Permeation Chromatography (GPC). All individual values and subranges of a CDF_{LS} of greater than 0.1200 are disclosed and included herein. For example, in some embodiments, the first region has a CDF_{LS} greater than 0.1200, greater than 0.1400, greater than 0.1600, greater than 0.1800, greater than 0.2000, greater than 0.2200, greater than 0.2400, greater than 0.2600, greater than 0.2800, or greater than 0.3000, where the CDF_{LS} is computed by measuring the area fraction of a low angle laser light scattering (LALLS) detector chromatogram greater than, or equal to, 1,00,000 g/mol molecular weight using Gel Permeation Chromatography (GPC). In other embodiments, the first region can have a CDF_{LS} in the range of from 0.1200 to 0.5000, from 0.1500 to 0.5000, from 0.2000 to 0.5000, from 0.2500 to 0.5000, from 0.3000 to 0.5000, from 0.1200 to 0.4500, from 0.1500 to 0.4500, 0.2000 to 0.4500, 0.2500 to 0.4500, 0.3000 to 0.4500, from 0.2000 to 0.4000, from 0.2500 to 0.4000, from 0.3000 to 0.4000, from 0.2000 to 0.3500, from 0.2500 to 0.3500, or from 0.3000 to 0.3500, where the CDF_{LS} is computed by measuring the area fraction of a low angle laser light scattering (LALLS) detector chromatogram greater than, or equal to, 1,000,000 g/mol molecular weight using Gel Permeation Chromatography (GPC).

In embodiments, the first region has an infrared cumulative detector fraction (CDF_{IR}) of greater than 0.0100 wherein the CDF_{IR} is computed by measuring the area fraction of an IR5 measurement channel (IR) detector chromatogram greater than, or equal to, 350,000 g/mol molecular weight using Gel Permeation Chromatography (GPC). All individual values and subranges of a CDF_{IR} of greater than 0.0100 are disclosed and included herein. For example, in some embodiments, the first region can have a CDF_{IR} greater than 0.0150, greater than 0.0200, or greater than 0.0250, where the CDF_{IR} is computed by measuring the area fraction of an IR5 measurement channel (IR) detector chromatogram greater than, or equal to, 350,000 g/mol molecular weight using Gel Permeation Chromatography (GPC). In other embodiments, the first region can have a CDF_{IR} in the range of from 0.0100 to 0.0500, from 0.0100 to 0.0450, from 0.0100 to 0.0400, from 0.0100 to 0.0375, from 0.0150 to 0.0500, from 0.0150 to 0.0450, from 0.0150 to 0.0400, from 0.0150 to 0.0375, from 0.0200 to 0.0500, from 0.0200 to 0.0450, from 0.0200 to 0.0400, from 0.0200 to 0.0375, from 0.0250 to 0.0500, from 0.0250 to 0.0450, from 0.0250 to 0.0400, from 0.0250 to 0.0375, where the CDF_{IR} is computed by measuring the area fraction of an IR5 measurement channel (IR) detector chromatogram greater than, or equal to, 350,000 g/mol molecular weight using Gel Permeation Chromatography (GPC).

In embodiments, the first region has an Mw(Abs) / Mw(GPC) of greater than 1.2, when calculated according to the test method described below. All individual values and subranges of greater than 1.2 are disclosed and included herein; for example, the first region can have an Mw(Abs) / Mw(GPC) of greater than 1.2, greater than 1.4, greater than 1.6, or greater than 1.8, or an Mw(Abs) / Mw(GPC) of from 1.2 to 2.0, 1.4 to 2.0, 1.6 to 2.0, or 1.8 to 2.0, when calculated according to the test method described below.

In embodiments, the first region has a gpcBR of greater than 0.20, when measured according to the test method described below. All individual values and subranges of greater than 0.20 are disclosed and included herein; for example, the first region can have a gpcBR of greater than 0.20, greater than 0.40, greater than 0.60, greater than 0.80, greater than 1.0, or greater than 1.1, or a gpcBR in the range of from 0.2 to 2.0, 0.4 to 2.0, 0.6 to 2.0, 0.8 to 2.0, or 1.0 to 2.0, when measured according to the test method described below.

The ethylene/alpha-olefin interpolymer can, for example, be produced via solution phase polymerization process using one or more loop reactors, isothermal reactors, continuous stirred tank reactors, and combinations thereof.

In general, the solution phase polymerization process occurs in one or more well-stirred reactors such as one or more loop reactors at a temperature in the range of from 115 to 250° C. ; for example, from 155 to 225° C., and at pressures in the range of from 300 to 1000 psi; for example, from 400 to 750 psi. In one embodiment in a dual reactor, the temperature in the first reactor temperature is in the range of from 115 to 190° C., for example, from 115 to 150° C., and the second reactor temperature is in the range of 150 to 200° C., for example, from 170 to 195° C. In another embodiment in a single reactor, the temperature in the reactor temperature is in the range of from 115 to 250° C., for example, from 155 to 225° C. The residence time in a solution phase polymerization process is typically in the range of from 2 to 30 minutes; for example, from 10 to 20 minutes. Ethylene, solvent, one or more catalyst systems, optionally one or more cocatalysts, optionally one or more impurity scavengers, and optionally one or more comonomers are fed continuously to one or more reactors. Exemplary solvents include, but are not limited to, isoparaffins. For example, such solvents are commercially available under the name ISOPAR E from ExxonMobil Chemical Co., Houston, Texas. The resultant mixture of the ethylene/alpha-olefin interpolymer and solvent is then removed from the reactor and the ethylene/alpha-olefin interpolymer is isolated. Solvent is typically recovered via a solvent recovery unit, i.e. heat exchangers and vapor liquid separator drum, and is then recycled back into the polymerization system.

In one embodiment, the ethylene/a-olefin interpolymer may be produced via a solution polymerization process in a dual reactor system, for example a dual loop reactor system, wherein ethylene and optionally one or more a-olefins are polymerized in the presence of one or more catalyst systems. Additionally, one or more cocatalysts may be present. In another embodiment, the ethylene/alpha-olefin interpolymer composition may be produced via a solution polymerization process in a single reactor system, for example a single loop reactor system, wherein ethylene and optionally one or more a- olefins are polymerized in the presence of one or more catalyst systems. Additionally, one or more cocatalysts may be present.

### Second Region and Polyester

The bicomponent fiber comprises a second region. The second region comprises a polyester.

In embodiments, the second region comprises a polyester selected from the group consisting of polyethylene terephthalate, polyethylene terephthalate glycol-modified, polybutylene terephthalate and combinations thereof. In embodiments, the polyester can have a density in a range of from 1.2 g/cm³ to 1.5 g/cm³. All values and subranges of a density in a range of from 1.2 g/cm³ to 1.5 g/cm³ are included and disclosed herein; for example; in some embodiments, the polyester has a density in the range from 1.2 g/cm³ to 1.5 g/cm³, from 1.25 g/cm³ to 1.5 g/cm³, from 1.3 g/cm³ to 1.5 g/cm³, from 1.35 g/cm³ to 1.5 g/cm³, from 1.2 g/cm³ to 1.45 g/cm³, from 1.25 g/cm³ to 1.45 g/cm³, from 1.3 g/cm³ to 1.45 g/cm³, or 1.35 g/cm³ to 1.45 g/cm³. In embodiments, the polyester has a molecular weight equivalent to an intrinsic viscosity (IV) of 0.5 to 1.4 (dl/g), where the IV is determined according to ASTM D4603 or 2857.

In embodiments, the second region comprises a polyester in an amount of at least 75 weight percent based on total weight of the second region. All individual values and subranges of at least 75 weight percent (wt.%) based on total weight of the second region are included and disclosed herein. For example, in one or more embodiments, the second region comprises a polyester in an amount of at least 75 wt.%, at least 80 wt.%, at least 90 wt.%, at least 95 wt.%, at least 99 wt.%, at least 99.5 wt.%, or at least 99.9 wt.%, based on total weight of the second region. In other embodiments, the second region comprises a polyester in an amount of from 75 to 80 wt.%, from 75 to 90 wt.%, from 75 to 99 wt.%, from 75 to 100 wt.%, from 80 to 90 wt.%, from 80 to 99 wt.%, from 90 to 99 wt.%, and from 90 to 100 wt.%, based on total weight of the second region of the bicomponent fiber.

In embodiments, where the second region comprises a polyester in amount of less than 100 wt.%, the second region can comprise additional components, such as, one or more other polymers, polymer blends, and/or one or more additives or modifiers. Other polymers or polymer blends can include another polyester, a polyethylene (e.g. polyethylene homopolymer or ethylene/alpha-olefin interpolymer), propylene-based polymer (e.g. polypropylene homopolymer, propylene-ethylene copolymer, or propylene/alpha-olefin interpolymer), or propylene-based plastomers or elastomers. The amount of the other polymer or other polymer blends may be up to 25 wt.% based on the total weight of the second region. For example, in embodiments, the second region can comprise up to 25 wt.% of propylene-based plastomers or propylene-based elastomers (such as VERSIFYl® polymers available from The Dow Chemical Company and VISTAMAXX® polymers available from ExxonMobil Chemical Co.), low modulus or/and low molecular weight polypropylene (such as L-MODU® polymer from Idemitsu), random copolypropylene, or propylene-based olefin block copolymers (such as Intune). Potential additives include, but are not limited to, antistatic agents, color enhancers, dyes, lubricants, fillers, pigments, primary antioxidants, secondary antioxidants, processing aids, UV stabilizers, anti-blocks, slip agents, tackifiers, fire retardants, anti-microbial agents, odor reducer agents, anti-fungal agents, and combinations thereof. Potential modifiers include, but are not limited to, dicarbonic acid units and glycol units. Examples of dicarbonic acid units are residues of isophthalic acid or of aliphatic dicarbonic acid (e.g. glutaric acid, adipinic acid, or sabacic acid), and examples of diol residues with a modifying action are those of longer chain diols (e.g., of propane diol or butane diol) of di- or triethylene glycol or, if available in a small quantity, of polyglycol with a molecular weight of 500 to 2000 g/mol. The second region can contain from about 0.01 or 0.1 or 1 to about 25 or about 20 or about 15 or about 10 weight percent by the combined weight of such additives and/or modifiers, based on the weight of the second region including such additives and/or modifiers.

### TEST METHODS

### Density

Density is measured in accordance with ASTM D-792, and expressed in grams/cm³ (g/cm³).

### Melt Index (I2)

Melt Index is measured in accordance with ASTM D 1238 at 190° C. and 2.16 kg, and is expressed in grams eluted/10 minutes (g/10 min).

### GPC

### Triple Detector Gel Permeation Chromatography (TDGPC)

The chromatographic system consisted of a PolymerChar GPC-IR (Valencia, Spain) high temperature GPC chromatograph equipped with an internal IR5 infra-red detector (IR5) and 4-capillary viscometer (DV) coupled to a Precision Detectors (Now Agilent Technologies) 2-angle laser light scattering (LS) detector Model 2040. For all Light scattering measurements, the 15 degree angle is used for measurement purposes. The autosampler oven compartment was set at 160° C. and the column compartment was set at 150° C. The columns used were 4 Agilent “Mixed A” 30 cm 20-micron linear mixed-bed columns and a 20-um pre-column. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration and calculation of the conventional molecular weight moments and the distribution (using the 20 um “Mixed A” columns) were performed according to the method described in the Conventional GPC procedure.

The Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log (MW and IV) results from a broad homopolymer polyethylene standard (Mw/Mn > 3) to the narrow standard column calibration results from the narrow standards calibration curve using PolymerChar GPCOne® Software. As used herein, “MW” refers to molecular weight.

The absolute molecular weight data was obtained in a manner consistent with that published by Zimm (Zimm, B.H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne® software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne®) were obtained using a light scattering constant, derived from one or more of the polyethylene standards mentioned below, and a refractive index concentration coefficient, dn/dc, of 0.104. Generally, the mass detector response (IR5) and the light scattering constant (determined using GPCOne®) should be determined from a linear standard with a molecular weight in excess of about 50,000 g/mole. The viscometer calibration (determined using GPCOne®) can be accomplished using the methods described by the manufacturer, or, alternatively, by using the published values of suitable linear standards, such as Standard Reference Materials (SRM) 1475a (available from National Institute of Standards and Technology (NIST)). A viscometer constant (obtained using GPCOne®) is calculated which relates specific viscosity area (DV) and injected mass for the calibration standard to its intrinsic viscosity (IV). The chromatographic concentrations are assumed low enough to eliminate addressing 2nd viral coefficient effects (concentration effects on molecular weight).

The absolute weight average molecular weight (Mw(Abs)) is obtained (using GPCOne®) from the Area of the Light Scattering (LS) integrated chromatogram (factored by the light scattering constant) divided by the mass recovered from the mass constant and the mass detector (IR5) area. The molecular weight and intrinsic viscosity responses are extrapolated at chromatographic ends where signal to noise becomes low (using GPCOne™). Other respective moments, Mn_{(Abs)} and Mz_{(Abs)} are be calculated according to equations 1-2 as follows:

$$M {n}_{\left(A b s\right)} = \frac{{\sum }_{}^{i} I {R}_{i}}{{\sum }_{}^{i} \left(\frac{I {R}_{i}}{{M}_{A b s o l u t e i}}\right)}$$

$$M {z}_{\left(A b s\right)} = \frac{{\sum }_{}^{i} \left(I {R}_{i} ∗ {M}_{A b s o l u t {e}_{i}} {}^{2}\right)}{{\sum }_{}^{i} \left(I {R}_{i} ∗ {M}_{A b s o l u t {e}_{i}}\right)}$$

### Conventional GPC

The chromatographic system consisted of a PolymerChar GPC-IR (Valencia, Spain) high temperature GPC chromatograph equipped with an internal IR5 infra-red detector (IR5) coupled to a Precision Detectors (Now Agilent Technologies) 2-angle laser light scattering (LS) detector Model 2040. For all Light scattering measurements, the 15 degree angle is used for measurement purposes. The autosampler oven compartment was set at 160° C. and the column compartment was set at 150° C. The columns used were 4 Agilent “Mixed A” 30 cm 20-micron linear mixed-bed columns. The chromatographic solvent used was 1,2,4 trichlorobenzene and contained 200 ppm of butylated hydroxytoluene (BHT). The solvent source was nitrogen sparged. The injection volume used was 200 microliters and the flow rate was 1.0 milliliters/minute.

Calibration of the GPC column set was performed with 21 narrow molecular weight distribution polystyrene standards with molecular weights ranging from 580 g/mol to 8,400,000 g/mol and were arranged in 6 “cocktail” mixtures with at least a decade of separation between individual molecular weights. The standards were purchased from Agilent Technologies. The polystyrene standards were prepared at 0.025 grams in 50 milliliters of solvent for molecular weights equal to or greater than 1,000,000 g/mol, and 0.05 grams in 50 milliliters of solvent for molecular weights less than 1,000,000 g/mol. The polystyrene standards were dissolved at 80° C. with gentle agitation for 30 minutes. The polystyrene standard peak molecular weights were converted to polyethylene molecular weights using Equation 1 (as described in Williams and Ward, J. Polym. Sci., Polym. Let., 6, 621 (1968)):

$$M {W}_{p o l y e h t y l e n e} = A \times {\left(M {w}_{p o l y s t y r e n e}\right)}^{B}$$

where MW is the molecular weight, A has a value of 0.4315 and B is equal to 1.0.

A fifth order polynomial was used to fit the respective polyethylene-equivalent calibration points. A small adjustment to A (from approximately 0.3950 to 0.440) was made to correct for column resolution and band-broadening effects such that such that linear homopolymer polyethylene standard is obtained at 120,000 Mw .The total plate count of the GPC column set was performed with decane (prepared at 0.04 g in 50 milliliters of TCB.) The plate count (Equation 4) and symmetry (Equation 5) were measured on a 200 microliter injection according to the following equations:

$$P l a t e C o u n t = 5.54 ∗ {\left(\frac{{\text{RV}}_{\text{Peak Max}}}{P e a k W i d t h a t \frac{1}{2} h e i g h t}\right)}^{2}$$

where RV is the retention volume in milliliters, the peak width is in milliliters, the peak max is the maximum height of the peak, and ½ height is ½ height of the peak maximum.

$$S y m m e t r y = \frac{\left(R e a r P e a k R {V}_{o n e t e n t h h e i g h t} - R {V}_{P e a k m a x}\right)}{\left(R {V}_{P e a k m a x} - F r o n t P e a k R {V}_{o n e t e n t h h e i g h t}\right)}$$

where RV is the retention volume in milliliters and the peak width is in milliliters, Peak max is the maximum position of the peak, one tenth height is ⅒ height of the peak maximum, and where rear peak refers to the peak tail at later retention volumes than the peak max and where front peak refers to the peak front at earlier retention volumes than the peak max. The plate count for the chromatographic system should be greater than 20,000 and symmetry should be between 0.98 and 1.22.

Samples were prepared in a semi-automatic manner with the PolymerChar “Instrument Control” Software, wherein the samples were weight-targeted at 2 mg/ml, and the solvent (contained 200 ppm BHT) was added to a pre nitrogen-sparged septa-capped vial, via the PolymerChar high temperature autosampler. The samples were dissolved for 2 hours at 160° C. under “low speed” shaking.

The calculations of Mn(conv), Mw(conv), and Mz(conv) were based on GPC results using the internal IR5 detector (measurement channel) of the PolymerChar GPC-IR chromatograph according to Equations 6-8, using PolymerChar GPCOne® software, the baseline-subtracted IR chromatogram at each equally-spaced data collection point (i), and the polyethylene equivalent molecular weight obtained from the narrow standard calibration curve for the point (i) from Equation 1.

$$M n \left(c o n v\right) = \frac{{\sum }_{}^{i} I {R}_{i}}{{\sum }_{}^{i} \left(\frac{I {R}_{i}}{{M}_{p o l y e t h y l e n {e}_{i}}}\right)}$$

$$M w \left(c o n v\right) = \frac{{\sum }_{}^{i} \left(I {R}_{i} ∗ {M}_{p o l y e t h y l e n {e}_{i}}\right)}{{\sum }_{}^{i} I {R}_{i}}$$

$$M z \left(c o n v\right) = \frac{{\sum }_{}^{i} \left(I {R}_{i} ∗ {M}_{p o l y e t h y l e n {e}_{i}} {}^{2}\right)}{{\sum }_{}^{i} \left(I {R}_{i} ∗ {M}_{p o l y e t h y l e n {e}_{i}}\right)}$$

In the low molecular weight region of the GPC elution curve, when the presence of a significant peak that is known to be caused by the presence of anti-oxidant or other additives, the presence of such peak will cause an underestimation of the number average molecular weight (Mn) of the polymer sample to give a overestimation of the sample polydispersity defined as Mw/Mn, where Mw is the weight average molecular weight. The true polymer sample molecular weight distribution can therefore be calculated from the GPC elution by excluding this extra peak. This process is commonly described as the peak skim feature in data processing procedures in liquid chromatographic analyses. In this process, this additive peak is skimmed off from the GPC elution curve before the sample molecular weight calculation is performed from the GPC elution curve. The plate count for the chromatographic system should be greater than 24,000 and symmetry should be between 0.98 and 1.22.

In order to monitor the deviations over time, a flowrate marker (decane) was introduced into each sample via a micropump controlled with the PolymerChar GPC-IR system. This flowrate marker (FM) was used to linearly correct the pump flowrate (Flowrate(nominal)) for each sample by RV alignment of the respective decane peak within the sample (RV(FM Sample)) to that of the decane peak within the narrow standards calibration (RV(FM Calibrated)). Any changes in the time of the decane marker peak are then assumed to be related to a linear-shift in flowrate (Flowrate(effective)) for the entire run. To facilitate the highest accuracy of a RV measurement of the flow marker peak, a least-squares fitting routine is used to fit the peak of the flow marker concentration chromatogram to a quadratic equation. The first derivative of the quadratic equation is then used to solve for the true peak position. After calibrating the system based on a flow marker peak, the effective flowrate (with respect to the narrow standards calibration) is calculated as Equation 9. Processing of the flow marker peak was done via the PolymerChar GPCOne® Software. Acceptable flowrate correction is such that the effective flowrate should be within +/-1% of the nominal flowrate.

$$\begin{matrix}\text{Flowrate} \left(\text{effective}\right) = \text{Flowrate} \left(\text{nominal}\right) * \\ \left(\text{RV} \left(\text{FM Calibrated}\right) / \text{RV} \left(\text{FM Sample}\right)\right)\end{matrix}$$

The Systematic Approach for the determination of multi-detector offsets is done in a manner consistent with that published by Balke, Mourey, et. al. (Mourey and Balke, Chromatography Polym. Chpt 12, (1992)) (Balke, Thitiratsakul, Lew, Cheung, Mourey, Chromatography Polym. Chpt 13, (1992)), optimizing triple detector log (MW and IV) results from a broad homopolymer polyethylene standard (Mw/Mn > 3) to the narrow standard column calibration results from the narrow standards calibration curve using PolymerChar GPCOne® Software.

The absolute molecular weight data was obtained in a manner consistent with that published by Zimm (Zimm, B.H., J. Chem. Phys., 16, 1099 (1948)) and Kratochvil (Kratochvil, P., Classical Light Scattering from Polymer Solutions, Elsevier, Oxford, NY (1987)) using PolymerChar GPCOne® software. The overall injected concentration, used in the determination of the molecular weight, was obtained from the mass detector area and the mass detector constant, derived from a suitable linear polyethylene homopolymer, or one of the polyethylene standards of known weight-average molecular weight. The calculated molecular weights (using GPCOne®) were obtained using a light scattering constant, derived from one or more of the polyethylene standards mentioned below, and a refractive index concentration coefficient, dn/dc, of 0.104. Generally, the mass detector response (IR5) and the light scattering constant (determined using GPCOne®) should be determined from a linear standard with a molecular weight in excess of about 50,000 g/mol.

### CDF Calculation Method

The calculation of the cumulative detector fractions (CDF) for the IR5 measurement detector (“CDF_{IR}”) and the low angle laser light scattering detector (“CDF_{LS}”) are accomplished by the following steps.

1) Linearly flow correct the chromatogram based on the relative retention volume ratio of the air peak between the sample and that of a consistent narrow standards cocktail mixture.

2) Correct the light scattering detector offset relative to the refractometer as described in the Gel Permeation Chromatography (GPC) section.

3) Calculate the molecular weights at each retention volume (RV) data slice based on the polystyrene calibration curve, modified by the polystyrene to polyethylene conversion factor of approximately (0.3950-0.44) as described in the Gel Permeation Chromatography (GPC) section.

4) Subtract baselines from the light scattering and refractometer chromatograms and set integration windows using standard GPC practices making certain to integrate all of the low molecular weight retention volume range in the light scattering chromatogram that is observable from the refractometer chromatogram (thus setting the highest RV limit to the same index in each chromatogram). Do not include any material in the integration which corresponds to less than 150 g/mol in either chromatogram.

5) Calculate the cumulative detector fraction (CDF) of the IR5 Measurement sensor (CDF_{IR}) and Low-Angle Laser Light Scattering (LALLS) chromatogram (CDF_{LS}) based on its baseline-subtracted peak height (H) from high to low molecular weight (low to high retention volume) at each data slice (j) according to Equations 10A and 10B.

$$C D {F}_{I R \geq 3350.000 M W} = \frac{{\sum }_{j = R V a t L o w e s t I n t e g r a t e d V o l u m e}^{j = R V a t 350.000 M W} H j}{{\sum }_{j = R V a t L o w e s t I n t e g r a t e d V o l u m e}^{j = R V a t H i g h e s t I n t e g r a t e d V o l u m e} H j}$$

$$C D {F}_{L S \geq 1 , 000 , 000 M W} = \frac{{\sum }_{j = R V a t L o w e s t I n t e g r a t e d V o l u m e}^{j = R V a t 1 , 000.000 M W} H j}{{\sum }_{j = R V a t L o w e s t I n t e g r a t e d V o l u m e}^{j = R V a t H i g h e s t I n t e g r a t e d V o l u m e} H j}$$

### gpcBR Branching Index by Triple Detector GPC (3D-GPC)

The gpcBR branching index is determined by first calibrating the light scattering, viscosity, and concentration detectors as described previously. Baselines are then subtracted from the light scattering, viscometer, and concentration chromatograms. Integration windows are then set to ensure integration of all of the low molecular weight retention volume range in the light scattering and viscometer chromatograms that indicate the presence of detectable polymer from the infrared (IR5) chromatogram. Linear polyethylene standards are then used to establish polyethylene and polystyrene Mark-Houwink constants. Upon obtaining the constants, the two values are used to construct two linear reference conventional calibrations for polyethylene molecular weight and polyethylene intrinsic viscosity as a function of elution volume, as shown in Equations (11) and (12):

$${\text{MW}}_{\text{PE}} = {\left({\text{K}}_{\text{PS}} / {\text{K}}_{\text{PE}}\right)}^{1 / {\text{α}}_{\text{PE}} + 1} ⋅ {\text{MW}}_{\text{PS}} {}^{{\text{α}}_{\text{PS}} + 1 / {\text{α}}_{\text{PE}} + 1}$$

$${\left[\text{η}\right]}_{\text{PE}} = {\text{K}}_{\text{PS}} ⋅ {\text{MW}}_{\text{PS}} {}^{\text{α} + 1} / {\text{MW}}_{\text{PE}}$$

The gpcBR branching index is a robust method for the characterization of long chain branching as described in Yau, Wallace W., “Examples of Using 3D-GPC—TREF for Polyolefin Characterization,” Macromol. Symp., 2007, 257, 29-45. The index avoids the “slice-by-slice” 3D-GPC calculations traditionally used in the determination of g′ values and branching frequency calculations, in favor of whole polymer detector areas. From 3D-GPC data, one can obtain the sample bulk absolute weight average molecular weight (Mw(abs)) by the light scattering (LS) detector, using the peak area method. The method avoids the “slice-by-slice” ratio of light scattering detector signal over the concentration detector signal, as required in a traditional g′ determination.

With 3D-GPC, sample intrinsic viscosities are also obtained independently using Equation (13). This area calculation offers more precision, because, as an overall sample area, it is much less sensitive to variation caused by detector noise and 3D-GPC settings on baseline and integration limits. More importantly, the peak area calculation is not affected by the detector volume offsets. Similarly, the high-precision sample intrinsic viscosity (IV) is obtained by the area method shown in Equation (13):

$$I {V}_{w} = \frac{{\sum }_{i} {c}_{i} I {V}_{i}}{{\sum }_{i} {c}_{i}} = \frac{{\sum }_{i} {η}_{s {p}_{i}}}{{\sum }_{i} {c}_{i}} = \frac{V i s c o m e t e r A r e a}{C o n c . A r e a}$$

where ηₛₚᵢ stands for the specific viscosity as acquired from the viscometer detector.

To determine the gpcBR branching index, the light scattering elution area for the sample polymer is used to determine the molecular weight of the sample. The viscosity detector elution area for the sample polymer is used to determine the intrinsic viscosity (IV or [η]) of the sample.

Initially, the molecular weight and intrinsic viscosity for a linear polyethylene standard sample, such as SRM1475a or an equivalent, are determined using the conventional calibrations (“cc”) for both molecular weight and intrinsic viscosity as a function of elution volume, per Equations (14) and (15):

$${\left[η\right]}_{c c} = \frac{{\sum }_{i} {c}_{i} I {V}_{i , c c}}{{\sum }_{i} {c}_{i}} = {\frac{{\sum }_{i} {c}_{i} K \left({M}_{i , c c}\right)}{{\sum }_{i} {c}_{i}}}^{\text{a}}$$

Equation (15) is used to determine the gpcBR branching index:

$$g p c B R = \left[\left(\frac{{\left[η\right]}_{c c}}{\left[η\right]}\right) {\left(\frac{{M}_{w}}{{M}_{w , c c}}\right)}^{{α}_{\text{PE}}} - 1\right]$$

wherein [η] is the measured intrinsic viscosity, [η]_{cc} is the intrinsic viscosity from the conventional calibration, Mw is the measured weight average molecular weight, and Mw_{,cc} is the weight average molecular weight of the conventional calibration. The weight average molecular weight by light scattering (LS) is commonly referred to as “absolute weight average molecular weight” or “Mw, Abs.” The Mw,cc from Equation (7) using conventional GPC molecular weight calibration curve (“conventional calibration”) is often referred to as “polymer chain backbone molecular weight,” “conventional weight average molecular weight,” and “Mw (conv).”

All statistical values with the “cc” subscript are determined using their respective elution volumes, the corresponding conventional calibration as previously described, and the concentration (Ci). The non-subscripted values are measured values based on the mass detector, LALLS, and viscometer areas. The value of K_{PE} is adjusted iteratively, until the linear reference sample has a gpcBR measured value of zero. For example, the final values for α and Log K for the determination of gpcBR in this particular case are 0.725 and –3.391, respectively, for polyethylene, and 0.722 and –3.993, respectively, for polystyrene. Once the K and α values have been determined using the procedure discussed previously, the procedure is repeated using the branched samples. The branched samples are analyzed using the final Mark-Houwink constants obtained from the linear reference as the best “cc” calibration values. For linear polymers, gpcBR calculated from Equation (15) will be close to zero, since the values measured by LS and viscometry will be close to the conventional calibration standard. For branched polymers, gpcBR will be higher than zero, especially with high levels of long chain branching, because the measured polymer molecular weight will be higher than the calculated Mw,cc, and the calculated IVcc will be higher than the measured polymer IV. In fact, the gpcBR value represents the fractional IV change due the molecular size contraction effect as the result of polymer branching. A gpcBR value of 0.5 or 2.0 would mean a molecular size contraction effect of IV at the level of 50% and 200%, respectively, versus a linear polymer molecule of equivalent weight. For these particular examples, the advantage of using gpcBR, in comparison to a traditional “g′ index” and branching frequency calculations, is due to the higher precision of gpcBR. All of the parameters used in the gpcBR index determination are obtained with good precision, and are not detrimentally affected by the low 3D-GPC detector response at high molecular weight from the concentration detector. Errors in detector volume alignment also do not affect the precision of the gpcBR index determination.

### Curvature

The amount of curvature is measured via optical microscopy. The amount of curvature is calculated based on the inverse of the radius of the helix formed by the fiber. This is equal to the radius of the circle formed by projection of the helix formed by the fiber on a surface perpendicular to it. Average value of at least 5 measurements is reported. Measurements are reported in units of 1/millimeter (mm⁻¹).

### Centroid Offset

The fiber is subjected to a 30 minute vapor stain region for electron beam stability. The stain is a water based solution of 2 wt.% concentration of ruthenium (III) tetrachloride hydrate and 6 wt.% sodium hypochlorite. The fiber is exposed to the vapors in a 75 ml screw-lid jar at ambient temperatures. A Bruker Nova Scanning Electron Microscope (SEM) is operated at 5 kV of accelerating voltage, a spot size of 4.5, a working distance between 5 and 8 mm, an objective aperture of 40 micrometers, and a scan rate of 45 micrometer seconds. Images are collected from secondary electron emissions collected by an Everhardt-Thornly detector. Image Metrology SPIP 6.7.8 image analysis software is used for measurement quantification. The diameter of a fiber’s cross section is measured using a single cord, and this measurement is divided in half to mark a mid-point as the fiber centroid (C_{f}). The core region of the bicomponent fiber is divided with two cords at 90° to visually create four quadrants of equal areas, and the intersection of the two cords defines the centroid of the core region (Cᵣ₂). The distance between the fiber centroid (C_{f}) and the centroid of the core region (Cᵣ₂) is measured, and then is divided by the radius of the fiber to calculate the fiber centroid offset (Pᵣ₂/r).

### EXAMPLES

A developmental resin (“Resin 1”) is prepared according to the following process and tables.

All raw materials (monomer and comonomer) and the process solvent (a narrow boiling range high-purity isoparaffinic solvent, commercially available under the tradename Isopar E from Exxon Mobil Corporation) are purified with molecular sieves before introduction into the reaction environment. Hydrogen is supplied pressurized as a high purity grade and is not further purified. The reactor monomer feed stream is pressurized via a mechanical compressor to above reaction pressure. The solvent and comonomer feed is pressurized via a pump to above reaction pressure. The individual catalyst components are manually batch diluted with purified solvent and pressured to above reaction pressure. All reaction feed flows are measured with mass flow meters and independently controlled with computer automated valve control systems.

A single reactor system is used. The reactor is a continuous solution polymerization reactor consisting of a liquid full, non-adiabatic, isothermal, circulating, loop reactor which mimics a continuously stirred tank reactor (CSTR) with heat removal. Independent control of all fresh solvent, monomer, comonomer, hydrogen, and catalyst component feeds is possible. The total fresh feed stream to each reactor (solvent, monomer, comonomer, and hydrogen) is temperature controlled typically between 15-50° C. to maintain a single solution phase by passing the feed stream through a heat exchanger. The total fresh feed to the polymerization reactor is injected into the reactor at two locations with approximately equal reactor volumes between each injection location. The fresh feed is controlled with each injector receiving half of the total fresh feed mass flow. The catalyst components are injected into the polymerization reactor through injection nozzles to introduce the components into the center of the reactor flow. The primary catalyst component feed is computer controlled to maintain the reactor monomer conversion at the specified value. The cocatalyst components are fed based on calculated specified molar ratios to the primary catalyst component. Immediately following each reactor feed injection location, the feed streams are mixed with the circulating polymerization reactor contents with static mixing elements. The contents of each reactor are continuously circulated through heat exchangers responsible for removing much of the heat of reaction and with the temperature of the coolant side responsible for maintaining an isothermal reaction environment at the specified temperature. Circulation around each reactor loop is provided by a pump.

The reactor effluent enters a zone where it is deactivated with the addition of and reaction with a suitable reagent (water). At this same reactor exit location other additives are added for polymer stabilization.

Following catalyst deactivation and additive addition, the reactor effluent enters a devolatization system where the polymer is removed from the non-polymer stream. The isolated polymer melt is pelletized and collected. The non-polymer stream passes through various pieces of equipment which separate most of the ethylene which is removed from the system. Most of the solvent and unreacted comonomer is recycled back to the reactor after passing through a purification system. A small amount of solvent and comonomer is purged from the process.

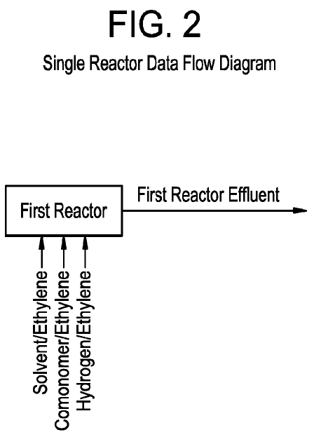

The reactor stream feed data flows that correspond to the values in Table 2 used to produce Resin 1 are graphically described in FIG. 2. The data are presented such that the complexity of the solvent recycle system is accounted for and the reaction system can be treated more simply as a once through flow diagram.

TABLE 1

Catalyst Information

| | |
|---|---|
| Description | Chemical Name or Structure |
| Primary Catalyst Component 1 | 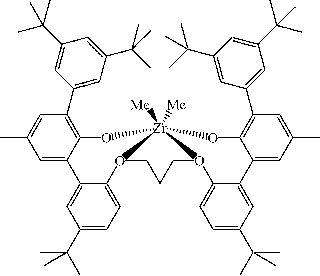 |
| Co-catalyst A | bis(hydrogenated tallow alkyl)methylammonium tetrakis(pentafluorophenyl)borate(1-) amine |
| Co-catalyst B | Triethyl aluminum |

TABLE 2

Production Conditions

| | | |
|---|---|---|
| | | Resin 1 |
| Reactor Configuration | Type | Single |
| Comonomer type | Type | 1-hexene |
| Reactor Feed Solvent / Ethylene Mass Flow Ratio | g/g | 3.47 |
| Reactor Feed Comonomer / Ethylene Mass Flow Ratio | g/g | 0.009 |
| Reactor Feed Hydrogen / Ethylene Mass Flow Ratio | g/g | 3.58E-04 |
| Reactor Temperature | °C | 185 |
| Reactor Pressure | barg | 38 |
| Reactor Ethylene Conversion | % | 93.5 |
| Reactor Catalyst Type (See also Table 1) | Type | Primary catalyst component 1 |
| Reactor Co-Catalyst 1 Type (See also Table 1) | Type | Co-catalyst A |
| Reactor Co-Catalyst 2 Type (See also Table 1) | Type | Co-catalyst B |
| Reactor Co-Catalyst 1 to Catalyst Molar Ratio (B to Catalyst Metal ratio) | mol/mol | 1.0 (B/Zr) |
| Reactor Co-Catalyst 2 to Catalyst Molar Ratio (A1 to Catalyst Metal ratio) | mol/mol | 4.1 (Al/Zr) |

Table 3 contains the melt index and density data for Resin 1.

TABLE 3

Properties of Resin 1

| Sample | Melt Index I₂ at 190° C. (g/10 min) | Density (g/cm³) |
|---|---|---|
| Resin 1 | 19 | 0.9500 |

The following materials were used in the examples.

Polymer 1 (Poly. 1) is a polymer blend of 80 wt.% of ASPUN™ 6835A and 20 wt.% of DOW™ 722 Low Density Polyethylene Resin. ASPUN™ 6835A is an ethylene/alpha-olefin interpolymer and a linear low density polyethylene fiber resin having a density of 0.9500 g/cm³ and Melt Index (I₂) of 17, and is commercially available from The Dow Chemical Company (Midland, MI). DOW™ 722 Low Density Polyethylene Resin is a low density polyethylene having a density of 0.918 g/cm³ and Melt Index (I₂) of 8 and is commercially available from The Dow Chemical Company (Midland, MI).

Polymer 2 (Poly. 2) is a polymer blend of 20 wt.% DOW™ 722 Low Density Polyethylene Resin and 80 wt.% of Resin 1.

Polymer 3 (Poly. 3) is 100 wt.% of ASPUN™ 6835A.

Polymer 4 (Poly. 4) is 100 wt.% of Resin 1.

Polymer 5 (Poly. 5) is a polymer blend of 80 wt. % of Resin 1 and 20 wt.% of DOW™ DMDA-8007 NT 7 High Density Polyethylene Resin. DOW™ DMDA-8007 NT 7 High Density Polyethylene Resin has a density of 0.965 g/cm³ and Melt Index (I₂) of 8.3 and is commercially available from The Dow Chemical Company, Midland, MI.

Poly. 1-5 are the materials used for forming the first region of the bicomponent fiber, as discussed further below.

Poly. 6 is EASTMAN™ Polyester F61HC commercially available from Eastman Chemical Company, Kingsport, TN. Poly. 6 is used for forming the second region of the bicomponent fiber as discussed below.

The CDF_{LS}– Greater than, or equal to, 1,000,000 g/mol molecular weight using Gel Permeation Chromatography (GPC), and CDF_{IR} – Greater than, or equal to, 350,000 g/mol molecular weight using Gel Permeation Chromatography (GPC), are reported in Table 4 for Poly. 1-5.

TABLE 4

The First Region - CDF Data

| | CDF_{LS} | CDF_{IR} |
|---|---|---|
| Poly. 1 | 0.3268 | 0.0356 |
| Poly 2. | 0.3015 | 0.0280 |
| Poly 3. | 0.1006 | 0.0086 |
| Poly. 4 | 0.0105 | 0.0005 |
| Poly. 5 | 0.0698 | 0.0057 |

The Conventional GPC measurements, Mn, Mw, Mz, and Mw/Mn, of the first region polymers are reported in Table 5.

TABLE 5

The First Region - Conventional GPC Data

| | Mn(GPC) | Mw(GPC) | Mz(GPC) | Mw(GPC) /Mn(GPC) |
|---|---|---|---|---|
| Poly. 1 | 16,067 | 78,893 | 431,870 | 4.91 |
| Poly 2. | 21,556 | 72,606 | 383,147 | 3.37 |
| Poly 3. | 16,632 | 55,186 | 160,743 | 3.32 |
| Poly. 4 | 27,877 | 47,483 | 81,470 | 2.17 |
| Poly. 5 | 21,301 | 54,088 | 133,291 | 2.54 |

The Absolute GPC measurements, Mn(Abs) and Mw(Abs), as well as the Mw(Abs) / Mw(GPC) values for Poly. 1-5 are reported in Table 8. Also, the gpcBR branching index measurements for Poly. 1-5 are reported in Table 6.

TABLE 6

The First Region - Absolute GPC and gpcBR Data

| | Mn(Abs) | Mw(Abs) | Mw(Abs) / Mw(GPC) | gpcBR |
|---|---|---|---|---|
| Poly. 1 | 14,508 | 146,623 | 1.86 | 1.1293 |
| Poly 2. | 20,037 | 132,607 | 1.83 | 1.09282 |
| Poly 3. | 15,719 | 61,531 | 1.11 | 0.1891 |
| Poly. 4 | 19,975 | 47,563 | 1.00 | 0.079 |
| Poly. 5 | 19,792 | 56,200 | 1.04 | 0.13847 |

### Formation of Fibers

Fibers are spun on a Hills Bicomponent Continuous Filament Fiber Spinning Line. Bicomponent fibers having an eccentric core-sheath configuration are made. The fibers are spun on the Hills Line according to the following conditions. Extruder profiles are adjusted to achieve a melt temperature of 240° C. Throughput rate of each hole is 1.5 ghm (grams per hour per minute). A Hills Bicomponent die is used and operated at a 40/60 core/sheath ratio (in weight) with the first region (sheath) in one extruder and second region (core) in another extruder, in accordance with Table 7 below, to form Inventive Examples 1 and 2, and Comparative Examples 3, 4, and 5. The die consists of 144 holes, with a hole diameter of 0.6 mm and a length/diameter (L/D) of 4/1. Quench air temperature and flow rate are set at 21-24° C., and 420 cfm (cubic feet per minute), respectively. After the quenching zone, a draw tension is applied on the 144 filaments by pneumatically entraining the filaments in a slot unit with an air stream. Velocity of the air stream is controlled by the slot aspirator pressure.

TABLE 7

Fiber Examples

| | First Region (Sheath) | Second Region (Core) | Weight Ratio of First Region: Second Region |
|---|---|---|---|
| Inventive Ex. 1 | Poly. 1 | Poly. 6 | 60:40 |
| Inventive Ex. 2 | Poly. 2 | Poly. 6 | 60:40 |
| Comparative Ex. 1 | Poly. 3 | Poly. 6 | 60:40 |
| Comparative Ex. 2 | Poly. 4 | Poly. 6 | 60:40 |
| Comparative Ex. 3 | Poly. 5 | Poly. 6 | 60:40 |

The CDF_{LS}– Greater than, or equal to, 1,000,000 g/mol molecular weight using Gel Permeation Chromatography (GPC), and CDF_{IR} – Greater than, or equal to, 350,000 g/mol molecular weight using Gel Permeation Chromatography (GPC), are reported in Table 8 for Inventive Examples 1 and 2 and Comparative Examples 1, 2, and 3.

TABLE 8

Fiber Data

| | CDF_{LS} | CDF_{IR} |
|---|---|---|
| Inventive Ex. 1 | 0.2838 | 0.0294 |
| Inventive Ex. 2 | 0.2723 | 0.0246 |
| Comparative Ex. 1 | 0.1444 | 0.0092 |
| Comparative Ex. 2 | 0.0000 | 0.0004 |
| Comparative Ex. 3 | 0.0825 | 0.0053 |

Table 9 shows the curvature data related to the Examples. Inventive Example 1 and Inventive Example 2, which have higher CDF_{LS} and CDF_{IR} and include a first region polymer with higher Mw(Abs), Mw(Abs) / Mw(GPC), gpcBR, CDF_{LS}, and CDF_{IR}, have significantly higher curvature than the Comparative Examples.

TABLE 9

Curvature Data

| | Slot Aspirator Pressure | Radius of fiber (µm) | Centroid Offset (Pᵣ₂/r) | Curvature (mm⁻¹) |
|---|---|---|---|---|
| Inventive Ex. 1 | 40 psi | 15.6 | Not measured | 1.61 |
| Inventive Ex. 2 | 40 psi | 16.1 | 0.56 | 1.52 |
| Comparative Ex. 1 | 40 psi | 13.4 | Not measured | 1.06 |
| Comparative Ex. 2 | 40 psi | 15.0 | 0.42 | 0.00 |
| Comparative Ex. 3 | 40 psi | 14.1 | 0.46 | 0.79 |

1. A bicomponent fiber comprising:
a fiber centroid;
a first region having a first centroid and a second region having a second centroid;
the first region comprising an ethylene/alpha-olefin interpolymer in an amount of at least 50 weight percent based on total weight of the first region and from 0 to 40 weight percent of a low density polyethylene based on total weight of the first region;
the first region having a light scattering cumulative detector fraction (CDF_{LS}) of greater than 0.1200, wherein the CDF_{LS} is computed by measuring the area fraction of a low angle laser light scattering (LALLS) detector chromatogram greater than, or equal to, 1,000,000 g/mol molecular weight using Gel Permeation Chromatography (GPC);
the second region comprising a polyester; and
wherein at least one of the first centroid and the second centroid is not the same as the fiber centroid.

2. The bicomponent fiber of claim 1, wherein the first region has an infrared cumulative detector fraction (CDF_{IR}) of greater than 0.0100 wherein the CDF_{IR} is computed by measuring the area fraction of an IR5 measurement channel (IR) detector chromatogram greater than, or equal to, 350,000 g/mol molecular weight using Gel Permeation Chromatography (GPC).

3. The bicomponent fiber of claim 1, wherein the ethylene/alpha-olefin interpolymer has a density in the range of from 0.910 to 0.964 g/cm³ and a melt index (I2), measured according to ASTM D1238, 190° C., 2.16 kg, in the range of from 10 to 60 g/10 minutes.

4. The bicomponent fiber of claim 1, wherein the first region has a molecular weight distribution, expressed as the ratio of the weight average molecular weight to number average molecular weight (M_{W(GPC)}/M_{n(GPC)}), of greater than 3.35.

5. The bicomponent fiber of claim 1, wherein the first region comprises from 10 to 30 weight percent of the low density polyethylene, based on the total weight of the first region.

6. The bicomponent fiber of claim 1, wherein the first region and the second region are arranged in a side-by-side or segmented pie configuration.

7. The bicomponent fiber of claim 1, wherein the first region and the second region are arranged in an eccentric core-sheath configuration, where the first region is the sheath of the bicomponent fiber and the second region is the core of the bicomponent fiber and the sheath region surrounds the core region.

8. The bicomponent fiber of claim 1, wherein the weight ratio of the first region to the second region is 90:10 to 10:90.

9. The bicomponent fiber of claim 1, wherein the curvature of the bicomponent fiber is at least 1.10 mm-¹.

10. A nonwoven comprising the bicomponent fiber of claim 1.

11. A bicomponent fiber comprising:
a fiber centroid;
a first region having a first centroid and a second region having a second centroid;
the first region comprising an ethylene/alpha-olefin interpolymer in an amount of at least 50 weight percent based on total weight of the first region and from 0 to 40 weight percent of a low density polyethylene based on total weight of the first region;
the second region comprising a polyester;
wherein at least one of the first centroid and the second centroid is not the same as the fiber centroid; and
wherein the fiber has a light scattering cumulative detector fraction (CDF_{LS}) of greater than 0.1600, wherein the CDF_{LS} is computed by measuring the area fraction of a low angle laser light scattering (LALLS) detector chromatogram greater than, or equal to, 1,000,000 g/mol molecular weight using Gel Permeation Chromatography (GPC).

12. The bicomponent fiber of claim 11, wherein the fiber has an infrared cumulative detector fraction (CDF_{IR}) of greater than 0.0125 wherein the CDF_{IR} is computed by measuring the area fraction of an IR5 measurement channel (IR) detector chromatogram greater than, or equal to, 350,000 g/mol molecular weight using Gel Permeation Chromatography (GPC).
